(19) United States
(12) Patent Application Publication
(10) Pub. No.: US 2025/0022469 A1
(43) Pub. Date: Jan. 16, 2025

(54) CLASSIFICATION DEVICE, CLASSIFICATION METHOD, AND CLASSIFICATION PROGRAM

(71) Applicant: NIPPON TELEGRAPH AND TELEPHONE CORPORATION, Tokyo (JP)

(72) Inventors: Setsuo YAMADA, Tokyo (JP); Takafumi HIKICHI, Tokyo (JP); Satoshi MIEDA, Tokyo (JP)

(73) Assignee: NIPPON TELEGRAPH AND TELEPHONE CORPORATION, Tokyo (JP)

(21) Appl. No.: 18/715,103

(22) PCT Filed: Dec. 1, 2021
(86) PCT No.: PCT/JP2021/044160

§ 371 Date: May 30, 2024

(51) Int. Cl. G10L 17/06; G10L 17/02

(52) U.S. Cl. CPC G10L 17/06; G10L 17/02

(57) ABSTRACT

A classification device includes a first identification unit that receives, as input, utterance data including an utterance of a first speaker and an utterance of a second speaker in a dialogue and, using a first identification model/rule, identifies respective utterance types of the utterances included in the utterance data, a second identification unit that receives, as input, the utterance data and the utterance type of each of the utterances, using a second identification model/rule preset according to the utterance types, identifies a first identification utterance indicating an inquiry and a second identification utterance in response to the first identification utterance in the utterance data, and outputs pair data of utterances indicating the first identification utterance and the second identification utterance, and a result classification unit that receives, as input, the output pair data of utterances, and, using a result classification model/rule, classifies a response result of the dialogue included in the utterance data as a response result kind.

### TECHNICAL FIELD

The disclosed technology relates to a classification device, a classification method, and a classification program.

### BACKGROUND ART

Conventionally, dialogue to handle a customer has been recorded and analyzed. An example of the dialogue required to be recorded and analyzed includes a dialogue between a customer and a handling person in a contact center. An example of a dialogue pattern of such dialogue is a dialogue pattern of an utterance of the customer in response to an inquiry of the handling person. The inquiry is a question, a request, or the like. In this dialogue pattern, the utterance of the customer is an answer (how the customer has answered). Also, another example of the dialogue pattern is a dialogue pattern of an utterance of the handling person in response to an inquiry of the customer. In this dialogue pattern, the utterance of the handling person is an explanation (how the handling person has explained). An utterance type of the utterance of the answer or the explanation described above can be regarded as “explanation or answer”. As for the examples of this dialogue pattern, the response result for the utterance type can be classified depending on what kind of response result has been produced to the dialogue. In a case of a response result indicating what kind of response has been produced regarding whether or not the customer is interested in an inquiry of the handling person, the response result kinds are “interested” and “not interested”. In addition, in a case where a responder answers a questionnaire, a plurality of response result kinds such as “applicable”, “not applicable”, and “not sure” are assumed.

In the above dialogue, by classifying response results into response result kinds in advance, the response results can efficiently be recorded and analyzed. As a method for classifying response results into response result kinds, there is a technique for estimating the response result kinds (Non Patent Literature 1). In this technology, learning data in which a response result kind is assigned to the utterance of the response result in advance as training data is prepared, and a model for estimating a response result kind from the learning data is created and used.

### CITATION LIST

### Non Patent Literature

Non Patent Literature 1: R.-E. Fan, K.-W. Chang, C.-J. Hsieh, X.-R. Wang, and C.-J. Lin. LIBLINEAR: A library for large linear classification Journal of Machine Learning Research 9 (2008), 1871-1874.

### SUMMARY OF INVENTION

### Technical Problem

As for an utterance of a second speaker in response to an inquiry of a first speaker, the same utterance contents may have different meanings and different response results depending on the content of the inquiry. For example, in a case where the inquiry content is an affirmative question sentence, and in a case where the inquiry content is a negative question sentence, and in a case where the utterance contents to these questions are both “Right, that is correct.”, the former indicates an affirmative answer, and the latter indicates a negative answer. However, in the conventional method, in a case where the utterances are classified into response result kinds such as “affirmative answer” and “negative answer”, and where one piece of training data for “Right, that is correct.” to which “affirmative answer” is assigned and the other piece to which “negative answer” is assigned are used as learning data, different response result kinds are assigned to the same utterance contents. This causes a problem that the accuracy of estimating the response result kind is lowered.

Furthermore, conventionally, a pair including an inquiry utterance and a response utterance to the inquiry utterance is regarded as a unit for use as learning data. However, it is not always the case that, immediately after the inquiry utterance of the first speaker, the utterance of the response result to the inquiry utterance (that is, the utterance whose utterance type is “explanation or answer” in the aforementioned dialogue pattern) comes. Therefore, the pair including the inquiry utterance of the first speaker and the utterance of the second speaker immediately after the inquiry utterance may not be correct learning data.

The disclosed technology has been made in view of the above points, and an object thereof is to provide a classification device, a classification method, and a classification program capable of accurately classifying response results into response result kinds depending on the utterance contents in a dialogue.

### Solution to Problem

A first aspect of the present disclosure is a classification device including a first identification unit that receives, as input, utterance data including an utterance of a first speaker and an utterance of a second speaker in a dialogue and, using a first identification model/rule for estimating an utterance type indicating a type of each of the utterances in the dialogue, identifies the respective utterance types of the utterances included in the utterance data, a second identification unit that receives, as input, the utterance data and the utterance type of each of the utterances, using a second identification model/rule preset according to the utterance types, identifies a first identification utterance indicating an inquiry and a second identification utterance in response to the first identification utterance in the utterance data, and outputs pair data of utterances indicating the first identification utterance and the second identification utterance, and a result classification unit that receives, as input, the output pair data of utterances, and, using a result classification model/rule for classifying a response result of the dialogue as a response result kind, classifies the response result of the dialogue included in the utterance data as the response result kind.

A second aspect of the present disclosure is a classification method for causing a computer to execute processing of receiving, as input, utterance data including an utterance of a first speaker and an utterance of a second speaker in a dialogue and, using a first identification model/rule for estimating an utterance type indicating a type of each of the utterances in the dialogue, identifying the respective utterance types of the utterances included in the utterance data, receiving, as input, the utterance data and the utterance type of each of the utterances, using a second identification model/rule preset according to the utterance types, identifying a first identification utterance indicating an inquiry and a second identification utterance in response to the first identification utterance in the utterance data, and outputting pair data of utterances indicating the first identification utterance and the second identification utterance, and receiving, as input, the output pair data of utterances, and, using a result classification model/rule for classifying a response result of the dialogue as a response result kind, classifying the response result of the dialogue included in the utterance data as the response result kind.

A third aspect of the present disclosure is a classification program for causing a computer to execute processing of receiving, as input, utterance data including an utterance of a first speaker and an utterance of a second speaker in a dialogue and, using a first identification model/rule for estimating an utterance type indicating a type of each of the utterances in the dialogue, identifying the respective utterance types of the utterances included in the utterance data, receiving, as input, the utterance data and the utterance type of each of the utterances, using a second identification model/rule preset according to the utterance types, identifying a first identification utterance indicating an inquiry and a second identification utterance in response to the first identification utterance in the utterance data, and outputting pair data of utterances indicating the first identification utterance and the second identification utterance, and receiving, as input, the output pair data of utterances, and, using a result classification model/rule for classifying a response result of the dialogue as a response result kind, classifying the response result of the dialogue included in the utterance data as the response result kind.

### Advantageous Effects of Invention

According to the disclosed technology, it is possible to accurately classify response results into response result kinds depending on the utterance contents in a dialogue.

### BRIEF DESCRIPTION OF DRAWINGS

FIG. 1 is a block diagram illustrating a hardware configuration of a classification device of the present embodiment.

FIG. 2 is a block diagram illustrating a functional configuration of the classification device of the present embodiment.

FIG. 3 is a diagram illustrating a configuration related to input and output of an input unit and a first identification unit.

FIG. 4 is a diagram illustrating a configuration related to input and output of a second identification unit and a result classification unit.

FIG. 5 is a flowchart illustrating a flow of classification processing performed by the classification device.

FIG. 6 is a flowchart illustrating a flow of processing for identifying an inquiry utterance.

FIG. 7 is a flowchart illustrating a flow of processing for identifying a response utterance.

### DESCRIPTION OF EMBODIMENTS

Hereinbelow, exemplary embodiments of the disclosed technology will be described with reference to the drawings. Note that, in the drawings, the same or equivalent components and portions are labeled with the same reference signs. Furthermore, dimensional ratios in the drawings are exaggerated for convenience of description and thus may be different from actual ratios.

A classification device according to the present embodiment provides specific improvement over a conventional method of classifying response results into response result kinds in a dialogue, and provides improvement in the technical field related to classification into response result kinds in a dialogue.

First, the above-described problems will be described using specific examples, and an outline of the technology of the present disclosure will be described.

In the following dialogue example, a first speaker is a handling person (operator), and a second speaker is a customer (service user). Note that the speakers are not limited thereto, and other users, bots, and the like are also assumed as speakers.

First, Dialogue Example 1 and Dialogue Example 2 will be described below to illustrate a case where the utterance contents are the same but the meanings of the utterances differ depending on the content of the inquiry.

### Dialogue Example 1

First speaker: “There is a safety confirmation service for the time of disaster, but you are not interested in it, are you?”

Second speaker: “Right, that is correct.”

### Dialogue Example 2

First speaker: “There is a safety confirmation service for the time of disaster, and you are interested in it, aren't you?”

Second speaker: “Right, that is correct.”

The response result of Dialogue Example 1 indicates that the second speaker is not interested, and the response result of Dialogue Example 2 indicates that the second speaker is interested.

Next, Dialogue Example 3 and Dialogue Example 4 will be described below to describe a case where there is no utterance whose utterance type is “explanation or answer” in response to an inquiry utterance of the first speaker immediately after the inquiry utterance.

### Dialogue Example 3

First speaker: “There is a safety confirmation service for the time of disaster, and are you interested in it?”

Second speaker: “What is the safety service?”

First speaker: “It is a service of sending a safety confirmation email to an employee and asking the employee to reply to it.”

Second speaker: “Then, I don't need it.”

### Dialogue Example 4

First speaker: “There is a safety confirmation service for the time of disaster, and are you interested in it?”

Second speaker: “What is the safety service?”

First speaker: “It is a service of sending a safety confirmation email to an employee and asking the employee to reply to it.”

Second speaker: “That is the one in which the email is automatically sent, right?”

In Dialogue Example 3, the second speaker once asks a question to the inquiry of the first speaker, and after receiving an answer, the second speaker gives utterance of “explanation or answer” to the first inquiry. In Dialogue Example 4, as in Dialogue Example 3, the second speaker once asks a question to the inquiry of the first speaker and receives an answer, but the second speaker then asks another question.

However, as in Dialogue Example 3 and Dialogue Example 4, it is not always the case that, immediately after the inquiry utterance of the first speaker, the utterance of the response result to the inquiry utterance comes. In Dialogue Example 3, the second speaker once asks a question to the inquiry of the first speaker, and after receiving an answer, the second speaker gives utterance of a response result to the first inquiry. In Dialogue Example 4, as in Dialogue Example 3, the second speaker once asks a question to the inquiry of the first speaker and receives an answer to the question, but the second speaker then asks another question.

As described above, in the dialogue handled in the present embodiment, it is assumed that the first speaker gives utterance (inquiry utterance) making an inquiry to the second speaker, and the second speaker gives utterance (response utterance) in response to the inquiry from the first speaker. In the technology of the present disclosure, the inquiry utterance is an example of a first identification utterance, and the response utterance is an example of a second identification utterance.

In an example of a dialogue between a customer and a handling person in a contact center, the first speaker is the handling person and the second speaker is the customer. Therefore, whether the speaker gives the inquiry utterance or the response is determined depending on the role assumed in the dialogue. Note that the case where there are two speakers, the first speaker and the second speaker, in the dialogue is taken as an example, but there may be three or more speakers as long as the inquiry utterance and the response utterance are given in the dialogue.

In general, there is a case where, depending on the utterance content of an inquiry utterance, the same utterance contents in response to the inquiry utterance should be regarded as different response results. In the conventional art, in that case, it is difficult to accurately classify the response results. Furthermore, it is also difficult to identify the inquiry utterance and the response result in response to the inquiry utterance from the utterance contents.

In the present embodiment, first, an utterance type is identified, and pair data of utterances (an inquiry utterance and a response utterance to the inquiry utterance) is identified using the identified utterance type. Then, in the present embodiment, response results are classified into response result kinds by using the identified pair data of utterances. By using the utterance type, even in a case where the response utterance does not come immediately after the inquiry utterance, the pair of utterances can be identified. Furthermore, by using the pair of utterances, even in a case where the content of the response utterance is the same, the response result can be classified accurately by the inquiry utterance corresponding to the response utterance.

Hereinbelow, a configuration of the present embodiment will be described.

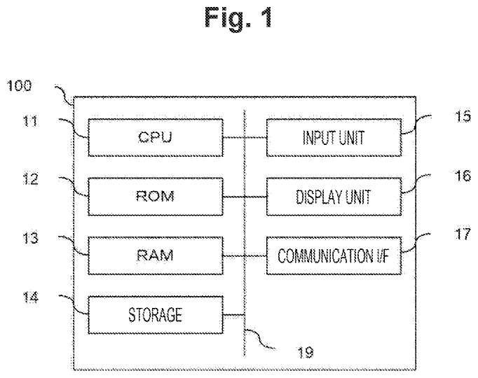

FIG. 1 is a block diagram illustrating a hardware configuration of a classification device 100.

As illustrated in FIG. 1, the classification device 100 includes a central processing unit (CPU) 11, a read only memory (ROM) 12, a random access memory (RAM) 13, a storage 14, an input unit 15, a display unit 16, and a communication interface (I/F) 17. The components are connected to be able to communicate with each other via a bus 19.

The CPU 11 is a central processing unit, and executes various programs and controls each of the units. That is, the CPU 11 reads a program from the ROM 12 or the storage 14, and executes the program using the RAM 13 as a working area. The CPU 11 performs control of each of the components described above and various types of calculation processing according to the program stored in the ROM 12 or the storage 14. In the present embodiment, a classification program is stored in the ROM 12 or the storage 14.

The ROM 12 stores various programs and various types of data. The RAM 13 serving as a working area temporarily stores programs or data. The storage 14 includes a storage device such as a hard disk drive (HDD) and a solid state drive (SSD) and stores various programs including an operating system and various types of data.

The input unit 15 includes a pointing device such as a mouse and a keyboard and is used to execute various inputs.

The display unit 16 is, for example, a liquid crystal display and displays various types of information. The display unit 16 may function as the input unit 15 by employing a touchscreen system.

The communication interface 17 is an interface for communicating with another device such as a terminal. For the communication, for example, a wired communication standard such as Ethernet (registered trademark) and FDDI, or a wireless communication standard such as 4G, 5G, and Wi-Fi (registered trademark) is used.

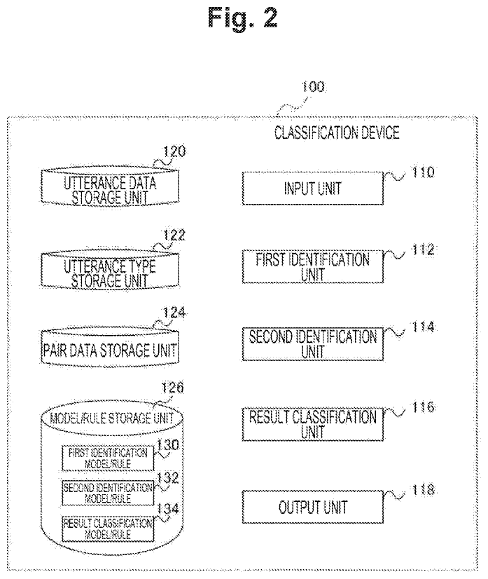

Next, each functional component of the classification device 100 will be described. FIG. 2 is a block diagram illustrating a configuration of the classification device of the present embodiment. Each functional component is achieved by the CPU 11 reading a classification program stored in the ROM 12 or the storage 14, loading the classification program into the RAM 13, and executing the classification program.

As illustrated in FIG. 2, the classification device 100 includes an input unit 110, a first identification unit 112, a second identification unit 114, a result classification unit 116, an output unit 118, an utterance data storage unit 120, an utterance type storage unit 122, a pair data storage unit 124, and a model/rule storage unit 126. The model/rule storage unit 126 stores a first identification model/rule 130, a second identification model/rule 132, and a result classification model/rule 134. Details of the models and the rules will be described below.

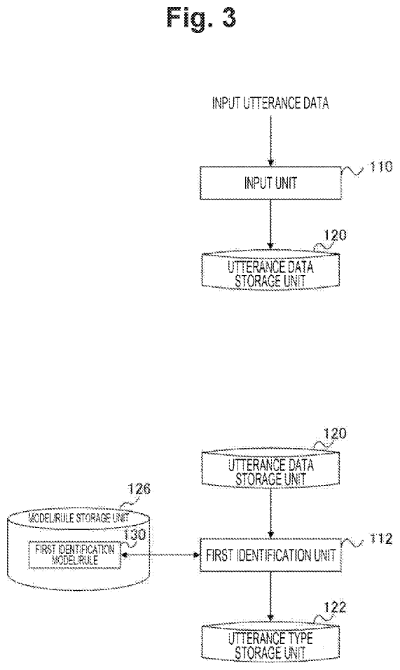

FIG. 3 illustrates a configuration related to input and output of the input unit 110 and the first identification unit 112.

As illustrated in FIG. 3, the input unit 110 receives input utterance data and stores the utterance data as utterance text in the utterance data storage unit 120. The input utterance data received by the input unit 110 is voice or character string data. The input utterance data includes, for example, the utterance of the first speaker and the utterance of the second speaker in each dialogue such as Dialogue Examples 1 to 4 described above. In a case where the input utterance data is a voice, the input unit 110 converts the input utterance data into text using voice recognition, and stores the utterance text in the utterance data storage unit 120 as utterance data. In addition, the input unit 110 identifies and labels the first speaker and the second speaker for the respective utterances by means of voice recognition. In a case where the input utterance data is a character string, the character string representing the utterance is utterance text, and the input unit 110 thus stores the utterance data as it is in the utterance data storage unit 120. In the following processing using the utterance data in each of the units, the utterance data as the utterance text is used. Note that the utterance data is not limited to the utterance text, and may be a voice signal.

As illustrated in FIG. 3, the first identification unit 112 receives utterance data of the utterance data storage unit 120 as input, and outputs utterance types of respective utterances. The first identification unit 112 receives utterance data as input, identifies utterance types of respective utterances included in the utterance data using the first identification model/rule 130 of the model/rule storage unit 126, and stores the utterance types in the utterance type storage unit 122. The utterance type storage unit 122 stores the respective utterances of utterance data and the utterance types identified for the utterances. That is, the data stored in the utterance type storage unit 122 is utterance data whose utterance type has been identified.

The first identification model/rule 130 is a model or rule for estimating/identifying an utterance type indicating a type of an utterance in the dialogue. In the case of using a model, for example, a model is created in advance by machine learning using learning data in which a label indicating an utterance type is assigned to an utterance, and is stored in the model/rule storage unit 126. Any method of multi-class classification may be used as a method of machine learning. In addition, a case of identifying an utterance type using a rule as the first identification model/rule 130 will be described. In the case of identifying an utterance type using a rule, for example, a list of ending words such as “ka” and “yone” indicating a question is created, and in a case where the ending word matches this list, the utterance type is “question”. A list of expressions that ask for a need is created, and in a case where the utterance type is once regarded as “question” and includes an expression that is in the list, the utterance type is “need hearing”. A list of ending words such as “kudasai” and “wo onegaishimasu” indicating a request is created, and in a case where the ending word matches this list, the utterance type is “request”. An utterance list of greetings and back-channel responses is created, and in a case where the utterance matches the list, the utterance type is “greeting or back-channel response”. Furthermore, in any cases other than the aforementioned cases, the utterance type is “explanation or answer”.

Examples of the utterance type are illustrated. “Need hearing”, “question”, and “explanation or answer” are used as labels indicating utterance types. In addition, a label “others” may be used as a label for a case where none of them is applicable. The label “others” is used for, for example, back-channel responses, greetings, requests, and the like. “Need hearing” is an utterance type defined as an utterance hearing a need. “Question” is an utterance type defined as an utterance asking a question.

“Explanation or answer” is an utterance type defined as an utterance giving an explanation or an answer. For example, in a case of using a model, the first identification model/rule 130 is trained in advance so as to estimate three utterance types from learning data to which three types of labels are assigned by machine learning. The first identification unit 112 uses the first identification model/rule 130 to identify which one of the utterance types of “need hearing”, “question”, and “explanation or answer” is applicable to each of the input utterances. In the technology of the present disclosure, “need hearing” is an example of a first utterance type, “question” is an example of a second utterance type, and “explanation or answer” is an example of a third utterance type.

Examples of the utterance types in the cases of Dialogue Examples 1 to 4 described above will be described. Each input is an utterance as utterance text included in utterance data, and each output is an utterance type. Note that each utterance is labeled with a speaker.

### Dialogue Example 1

(Input) First speaker: utterance text “There is a safety confirmation service for the time of disaster, but you are not interested in it, are you?”/(Output) Utterance type “need hearing”

(Input) Second speaker: utterance text “Right, that is correct.”/(Output) Utterance type “explanation or answer”

### Dialogue Example 2

(Input) First speaker: utterance text “There is a safety confirmation service for the time of disaster, and you are interested in it, aren't you?”/(Output) Utterance type “need hearing”

(Input) Second speaker: utterance text “Right, that is correct. ”/(Output) Utterance type “explanation or answer”

### Dialogue Example 3

(Input) First speaker: utterance text “There is a safety confirmation service for the time of disaster, and are you interested in it?”/(Output) Utterance type “need hearing”

(Input) Second speaker: utterance text “What is the safety service?”/(Output) Utterance type “question”

(Input) First speaker: utterance text “It is a service of sending a safety confirmation email to an employee and asking the employee to reply to it. ”/(Output) Utterance type “explanation or answer”

(Input) Second speaker: utterance text “Then, I don't need it. ”/(Output) Utterance type “explanation or answer”

### Dialogue Example 4

(Input) First speaker: utterance text “There is a safety confirmation service for the time of disaster, and are you interested in it?”/(Output) Utterance type “need hearing”

(Input) Second speaker: utterance text “What is the safety service?”/(Output) Utterance type “question”

(Input) First speaker: utterance text “It is a service of sending a safety confirmation email to an employee and asking the employee to reply to it. ”/(Output) Utterance type “explanation or answer”

(Input) Second speaker: utterance text “That is the one in which the email is automatically sent, right?”/(Output) Utterance type “question”

Note that, in a case where the utterance cannot be classified as any of the utterance types, the utterance type is set to “NULL” or “others”. In a case where the label “others” is prepared, assignment is performed using the first identification model/rule 130. In a case of using a model as the first identification model/rule 130, the label “others” is assigned in a case where the estimation results of any labels have low likelihood. In a case of using a rule as the first identification model/rule 130, the label “others” is assigned in a case where any of the rules for determining the respective labels are not applicable. Furthermore, the number of the utterance types is not limited to three, and the first identification model/rule 130 may be prepared in advance and used for three or more utterance types. For example, the label “explanation or answer” includes two cases of explanation and answer, but may be divided into labels, that is, a label “explanation” and a label “answer”, and four utterance types may be used in total.

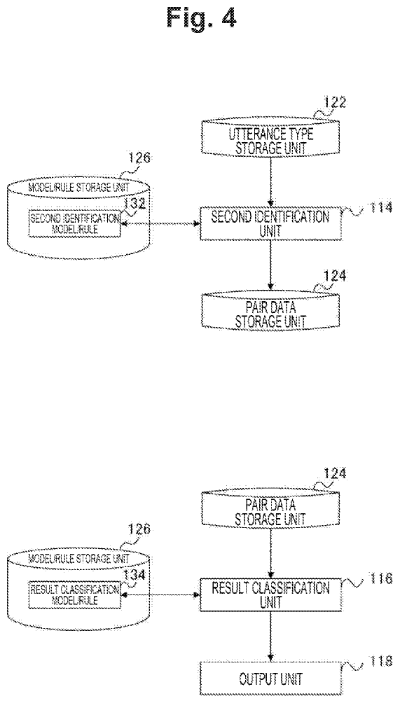

FIG. 4 illustrates a configuration related to input and output of the second identification unit 114 and the result classification unit 116.

As illustrated in FIG. 4, the second identification unit 114 receives respective pieces of utterance data of utterances in the utterance type storage unit 122 and the utterance types as input, and outputs pair data of utterances. The pair data of utterances is data indicating an inquiry utterance and a response utterance to the inquiry utterance. The second identification unit 114 receives utterance types of utterances as input, identifies an inquiry utterance and a response utterance in utterance data using the second identification model/rule 132 of the model/rule storage unit 126, and stores pair data of the utterances in the pair data storage unit 124.

The second identification model/rule 132 is set according to the utterance type, and is a model/rule for identifying an inquiry utterance and a response utterance. A case where a model is used will be described. A pair including an utterance whose utterance type is “need hearing” and an utterance whose utterance type is “answer utterance” is provided with a label of whether or not the pair is a pair of corresponding utterances to create learning data, and a model for estimating whether or not the pair is a pair of corresponding utterances is created. A pair including an utterance whose utterance type is “need hearing” and a subsequently coming utterance whose utterance type is “answer utterance” is input, and in a case where it is estimated that the pair is a pair of corresponding utterances, the pair of utterances is stored as pair data of utterances. An utterance whose utterance type is “need hearing” and a subsequently coming utterance whose utterance type is “answer utterance” are regarded as an input pair of utterances until a subsequent utterance whose utterance type is “need hearing” comes, until the pair is determined as a pair of corresponding utterances, or until the call ends. The same applies to the learning data when training a model. Next, a case where a rule is used will be described. (1) A rule for identifying an inquiry utterance is that the utterance is one in which the speaker is the first speaker, and that the utterance type is “need hearing”. Then, after identifying the inquiry utterance, (2) a rule for identifying a response utterance is applied. (2) The rule for identifying a response utterance is used for a case (2A) where the dialogue such as Dialogue Examples 1 and 2 has two utterances and a case (2B) where the dialogue such as Dialogue Examples 3 and 4 has four utterances. Note that, for convenience of description, in the description of the following dialogue examples, the inquiry utterance and the response utterance in the pair data of utterances are provided with < >as parentheses so as to be distinguished from the utterance type.

The rule for (2A) has a condition that the order of the two utterances in the dialogue satisfies the following conditions. (2A-1) is a condition for an utterance whose utterance order is first, and (2A-2) is a condition for an utterance whose utterance order is second.
(2A-1) Utterance of first speaker is <inquiry utterance>
(2A-2) Utterance type of utterance of second speaker is “explanation or answer”

In the above case, (2A-2) is identified as the response utterance.

The rule for (2B) has a condition that the order of the four utterances in the dialogue satisfies the following conditions. (2B-1) is a condition for an utterance whose utterance order is first, (2B-2) is a condition for an utterance whose utterance order is second, (2B-3) is a condition for an utterance whose utterance order is third, and (2B-4) is a condition for an utterance whose utterance order is fourth.
(2B-1) Utterance of first speaker is <inquiry utterance>
(2B-2) Utterance type of utterance of second speaker is “question”
(2B-3) Utterance type of utterance of first speaker is “explanation or answer”
(2B-4) Utterance type of utterance of second speaker is “explanation or answer”

In the above case, (2B-4) is identified as the response utterance.

As described above, in (2) the rule for identifying a response utterance, the conditions for the combination of the speaker and the utterance type for each utterance in the order of utterances are defined for the dialogue included in the utterance data. For identifying the response utterance, the utterance types “question” and “explanation or answer” are used.

In addition, as a premise in the case of identifying the response utterance, the inquiry utterance of the first speaker needs to be identified earlier. Therefore, the second identification unit 114 identifies the inquiry utterance, checks the utterance following the inquiry utterance according to the conditions for (2), and identifies the response utterance. The second identification unit 114 outputs a pair including the inquiry utterance and the response utterance identified in the utterance data as pair data of utterances.

Examples of the pair data of utterances in the cases of Dialogue Examples 1 to 4 described above will be described. Each input is an utterance type, and each output is one of an inquiry utterance and a response utterance that are pair data of utterances. Note that utterance text in each dialogue example is omitted for convenience of description.

### Dialogue Example 1

(Input) First speaker: utterance type “need hearing”/(Output) <Inquiry utterance>
(Input) Second speaker: utterance type “explanation or answer”/(Output) <Response utterance>

In the case of Dialogue Example 1, the utterance text “There is a safety confirmation service for the time of disaster, but you are not interested in it, are you?” of the first speaker is <inquiry utterance>, and the utterance type of the utterance text “Right, that is correct.” of the second speaker is “explanation or answer”. In this case, the utterance text of the second speaker is <response utterance>.

### Dialogue Example 2

(Input) First speaker: utterance type “need hearing”/(Output) <Inquiry utterance>
(Input) Second speaker: utterance type “explanation or answer”/(Output) <Response utterance>

In the case of Dialogue Example 2, the utterance text “There is a safety confirmation service for the time of disaster, and you are interested in it, aren't you?” of the first speaker is <inquiry utterance>, and the utterance type of the utterance text “Right, that is correct.” of the second speaker is “explanation or answer”. In this case, the utterance text of the second speaker is <response utterance>.

### Dialogue Example 3

(Input) First speaker: utterance type “need hearing”/(Output) <Inquiry utterance>
(Input) Second speaker: utterance type “question”
(Input) First speaker: utterance type “explanation or answer”
(Input) Second speaker: utterance type “explanation or answer”/(Output) <Response utterance>

In the case of Dialogue Example 3, the utterance text “There is a safety confirmation service for the time of disaster, and are you interested in it?” of the first speaker is <inquiry utterance>, and the utterance type of the utterance text “What is the safety service?” of the second speaker is “question”. Subsequently, the utterance type of the utterance text “It is a service of sending a safety confirmation email to an employee and asking the employee to reply to it.” of the first speaker is “explanation or answer”. Subsequently, the utterance type of the utterance text “Then, I don't need it.” of the second speaker is “explanation or answer”. In this case, the last utterance text, whose utterance type is “explanation or answer”, of the second speaker is <response utterance>.

### Dialogue Example 4

(Input) First speaker: utterance type “need hearing”/(Output) <Inquiry utterance>
(Input) Second speaker: utterance type “question”
(Input) First speaker: utterance type “explanation or answer”
(Input) Second speaker: utterance type “question”/(Output) <NULL>

Dialogue Example 4 satisfies the conditions for the inquiry utterance, but does not conform to the rule for identifying the response utterance. Therefore, <response utterance>does not exist, and <NULL>is applied.

Note that, in a case where the fourth utterance is the utterance type “question” of the second speaker as in the above example, the range of the rule for identifying a response utterance may be widened. In this case, for example, whether or not the following utterance such as the fifth and sixth utterances is the utterance type “explanation or answer” of the second speaker is set as a condition. In a case where the condition is satisfied, the last utterance is identified as <response utterance>and is identified as <response utterance>in the pair data of utterances. In a case where the utterance type of the fourth utterance is “NULL”, the range of the conditions can be widened in a similar manner. By widening the range of the rule for identifying the response utterance in this manner, it is possible to identify the response utterance and output the pair data of utterances even in a case where the dialogue is not progressing as expected.

As illustrated in FIG. 4, the result classification unit 116 receives the pair data of utterances in the pair data storage unit 124 as input, and outputs a classification result of a response result kind for the dialogue. The result classification unit 116 receives the pair data of utterances as input and classifies the response result of the dialogue included in the utterance data as a response result kind “there is a need” or “there is no need” indicating the presence or absence of a need, using the result classification model/rule 134 of the model/rule storage unit 126.

The result classification model/rule 134 is a model/rule for classifying the response result of the dialogue as a response result kind. In a case of using a model as the result classification model/rule 134, for example, a model is created in advance by machine learning using learning data in which a classification label of a response result kind is assigned, and is stored in the model/rule storage unit 126. For example, “there is a need” and “there is no need” are used as classification labels for the response result. Using learning data provided with the two kinds of label, a model for classifying response results into the two kinds is trained in advance by machine learning. The result classification unit 116 uses the result classification model/rule 134 to classify the response result in pair data of utterances as the response result kind “there is a need” or “there is no need”. Furthermore, in a case of using a rule as the result classification model/rule 134, a list of negative expressions such as “no” and “not” is created. In the rule, in a case where the inquiry utterance in the pair data of utterances includes a negative expression that is in the negative expression list, the inquiry utterance is determined as “negative”, and in a case where the inquiry utterance includes no negative expression, the inquiry utterance is determined as “affirmative”. In the rule, in a case where the response utterance in the pair data of utterances includes a negative expression that is in the negative expression list, the response utterance is determined as “negative”, and in a case where the response utterance includes no negative expression, the response utterance is determined as “affirmative”. The presence/absence of a need is determined according to the following rule of combination of negative and affirmative determinations for the inquiry utterance and the response utterance. Each combination is provided with < >as parentheses, and a rule for the combination is indicated by a right arrow →. The combination and the determination are shown in the form of <inquiry utterance, response utterance>→need determination. One determination case is <affirmative, affirmative>→there is a need. Another determination case is <affirmative, negative>→there is no need. Still another determination case is <negative, affirmative>→there is no need. Yet another determination case is <negative, negative>→there is a need.

Each of Dialogue Examples 1 to 4 is classified as a response result kind in the following manner. Dialogue Example 1 is classified as “there is a need”, Dialogue Example 2 is classified as “there is no need”, Dialogue Example 3 is classified as “there is no need”, and Dialogue Example 4 is classified as “not classified” “Not classified” means that the response utterance that should be in the pair data of utterances does not come, thus the dialogue is not intended to be input into the result classification model/rule 134, and classification as a response result kind is not performed.

Note that response result kinds into which response results are classified by the result classification model/rule 134 are not limited to “there is a need” and “there is no need”. For example, the result classification model/rule 134 may be used to classify response results into response result kinds by preparing labels that have different degrees of need. In a case where there is a need, “there is a slight need”, “there is a need”, and “there is a considerable need” are used, and in a case where there is no need, “there is not a considerable need”, “there is no need”, and “there is no need at all” are used. In this manner, the result classification unit 116 may classify response results into response result kinds according to the degree of need using the result classification model/rule 134.

The output unit 118 outputs a classification result for the response result kind for the dialogue obtained by the result classification unit 116.

Next, an operation of the classification device 100 will be described.

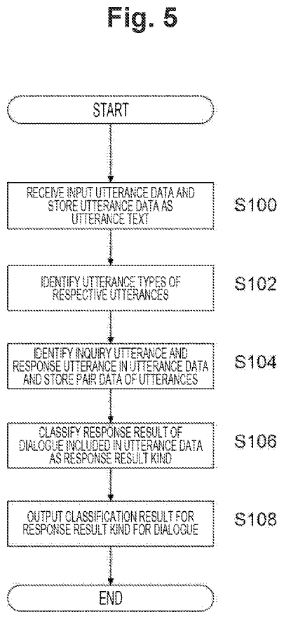

FIG. 5 is a flowchart illustrating a flow of classification processing performed by the classification device 100. The classification processing is performed by the CPU 11 reading the classification program from the ROM 12 or the storage 14, loading the classification program into the RAM 13, and executing the classification program.

In step S100, the CPU 11 functions as the input unit 110 to receive input utterance data and store the utterance data as utterance text in the utterance data storage unit 120.

In step S102, the CPU 11 functions as the first identification unit 112 to receive the utterance data as input, identify utterance types of respective utterances included in the utterance data using the first identification model/rule 130, and store the utterance types in the utterance type storage unit 122.

In step S104, the CPU 11 functions as the second identification unit 114 to receive the utterance types of the utterances as input, identify an inquiry utterance and a response utterance in the utterance data using the second identification model/rule 132, and store pair data of the utterances in the pair data storage unit 124.

In step S106, the CPU 11 functions as the result classification unit 116 to receive the pair data of utterances as input and classify the response result of the dialogue included in the utterance data as a response result kind, using the result classification model/rule 134. For example, in a case where “there is a need” and “there is no need” are defined as response result kinds, the response result is classified as “there is a need” or “there is no need” indicating the presence or absence of a need. Note that, in the steps, in a case where there is no response utterance that should be in the pair data of utterances, “not classified” is output as a classification result.

In step S108, the CPU 11 functions as the output unit 118 to output the classification result for the response result kind for the dialogue.

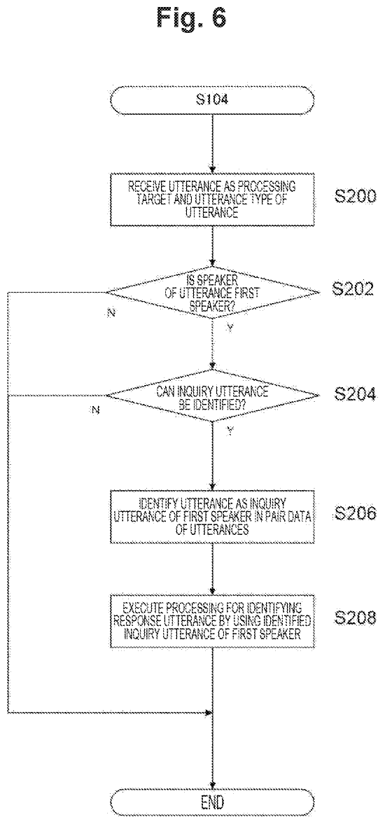

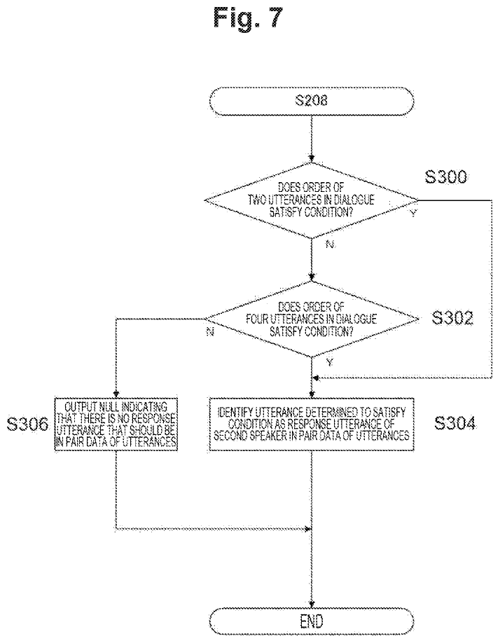

Next, the processing in step S104 will be described with reference to the flowcharts in FIGS. 6 and 7. In the processing in step S104, processing for identifying an inquiry utterance and processing for identifying a response utterance are executed.

FIG. 6 illustrates a flow of processing for identifying an inquiry utterance. In the processing, each utterance with an utterance type in the utterance type storage unit 122 is processed as a processing target.

In step S200, the CPU 11 receives an utterance as a processing target and an utterance type of the utterance as input from the utterance type storage unit 122.

In step S202, the CPU 11 determines whether the speaker of the utterance as a processing target is the first speaker. In a case where the speaker is determined to be the first speaker, the processing proceeds to step S204, and in a case where the speaker is determined not to be the first speaker (that is, in a case where the speaker is determined to be the second speaker), the processing ends.

In step S204, the CPU 11 determines whether or not the inquiry utterance can be identified using the utterance type of the utterance as a processing target. In a case where it is determined that the identification has been made, the processing proceeds to step S206, and in a case where it is determined that the identification has not been made, the processing ends. The condition to determine whether the utterance is the inquiry utterance is, for example, that the utterance type of the utterance is “need hearing”. In the processing performed by the second identification unit 114, the inquiry utterance (first identification utterance) is identified according to the utterance type of the utterance of the first speaker as described above, and the response utterance (second identification utterance) is identified in the following step according to the utterance type of the utterance of the second speaker after the inquiry utterance.

In step S206, the CPU 11 identifies the utterance as a processing target as the inquiry utterance of the first speaker in the pair data of utterances.

In step S208, the CPU 11 executes processing for identifying the response utterance by using the identified inquiry utterance of the first speaker.

FIG. 7 illustrates a flow of processing for identifying a response utterance. The processing for identifying a response utterance is executed as a subroutine of step S208. In the processing for identifying a response utterance, the input is the identified inquiry utterance of the first speaker and the utterance type of the utterance in response to the inquiry utterance. It is preferable to determine how many utterances are to be used to identify the utterance in response to the inquiry utterance in the rule for identifying the response utterance.

In step S300, the CPU 11 determines whether or not the order of the two utterances in the dialogue satisfies the condition for (2A) described above. In a case where the condition for (2A) is satisfied, the processing proceeds to step S304, and in a case where the condition for (2A) is not satisfied, the processing proceeds to step S302.

In step S302, the CPU 11 determines whether or not the order of the four utterances in the dialogue satisfies the condition for (2B) described above. In a case where the condition for (2B) is satisfied, the processing proceeds to step S304, and in a case where the condition for (2B) is not satisfied, the processing proceeds to step S306.

In step S304, the CPU 11 identifies the utterance determined to satisfy the condition in step S300 or S302 as the response utterance of the second speaker in the pair data of utterances. The utterance determined to satisfy the condition is the last utterance in the order of the utterances in response to the inquiry utterance.

In step S306, the CPU 11 outputs (NULL) indicating that there is no response utterance that should be in the pair data of utterances.

As described above, according to the classification device 100 of the present embodiment, it is possible to accurately classify response results into response result kinds depending on the utterance contents in a dialogue.

Note that the classification processing executed by the CPU reading software (program) in the above embodiment may be executed by various processors other than the CPU. Examples of the processors in this case include a programmable logic device (PLD) whose circuit configuration can be changed after the manufacturing, such as a field-programmable gate array (FPGA), a graphics processing unit (GPU), and a dedicated electric circuit that is a processor having a circuit configuration exclusively designed for executing specific processing, such as an application specific integrated circuit (ASIC). The classification processing may be executed by one of the various processors or may be executed by a combination of two or more processors of the same type or different types (for example, a combination of a plurality of FPGAs or a combination of a CPU and an FPGA). More specifically, a hardware structure of the various processors is an electric circuit in which circuit elements such as semiconductor elements are combined.

In the above embodiment, the aspect in which the classification program is stored (installed) in advance in the storage 14 has been described, but the present invention is not limited thereto. The program may be provided in the form of a program stored in a non-transitory storage medium such as a compact disk read only memory (CD-ROM), a digital versatile disk read only memory (DVD-ROM), and a universal serial bus (USB) memory. In addition, the program may be downloaded from an external device via a network.

Regarding the above embodiment, the following supplementary notes are further disclosed.

### Supplementary Note 1

A classification device including
a memory, and
at least one processor connected to the memory,
wherein the processor is configured to
receiving, as input, utterance data including an utterance of a first speaker and an utterance of a second speaker in a dialogue and, using a first identification model/rule for estimating an utterance type indicating a type of each of the utterances in the dialogue, identifying the respective utterance types of the utterances included in the utterance data,
receiving, as input, the utterance data and the utterance type of each of the utterances, using a second identification model/rule preset according to the utterance types, identifying a first identification utterance indicating an inquiry and a second identification utterance in response to the first identification utterance in the utterance data, and outputting pair data of utterances indicating the first identification utterance and the second identification utterance, and
receiving, as input, the output pair data of utterances, and, using a result classification model/rule for classifying a response result of the dialogue as a response result kind, classifying the response result of the dialogue included in the utterance data as the response result kind.

### Supplementary Note 2

A non-transitory storage medium storing a program executable by a computer to execute classification processing, the non-transitory storage medium
receiving, as input, utterance data including an utterance of a first speaker and an utterance of a second speaker in a dialogue and, using a first identification model/rule for estimating an utterance type indicating a type of each of the utterances in the dialogue, identifying the respective utterance types of the utterances included in the utterance data,
receiving, as input, the utterance data and the utterance type of each of the utterances, using a second identification model/rule preset according to the utterance types, identifying a first identification utterance indicating an inquiry and a second identification utterance in response to the first identification utterance in the utterance data, and outputting pair data of utterances indicating the first identification utterance and the second identification utterance, and
receiving, as input, the output pair data of utterances, and, using a result classification model/rule for classifying a response result of the dialogue as a response result kind, classifying the response result of the dialogue included in the utterance data as the response result kind.

### REFERENCE SIGNS LIST

100 Classification device
110 Input unit
112 First identification unit
114 Second identification unit
116 Result classification unit
118 Output unit
120 Utterance data storage unit
120 Utterance type storage unit
124 Pair data storage unit
126 Model/rule storage unit
130 First identification model/rule
130 Second identification model/rule
134 Result classification model/rule

1. A classification device comprising:
a first identification unit that receives, as input, utterance data including an utterance of a first speaker and an utterance of a second speaker in a dialogue and, using a first identification model/rule for estimating an utterance type indicating a type of each of the utterances in the dialogue, identifies the respective utterance types of the utterances included in the utterance data;
a second identification unit that receives, as input, the utterance data and the utterance type of each of the utterances, using a second identification model/rule preset according to the utterance types, identifies a first identification utterance indicating an inquiry and a second identification utterance in response to the first identification utterance in the utterance data, and outputs pair data of utterances indicating the first identification utterance and the second identification utterance; and
a result classification unit that receives, as input, the output pair data of utterances, and, using a result classification model/rule for classifying a response result of the dialogue as a response result kind, classifies the response result of the dialogue included in the utterance data as the response result kind.

2. The classification device according to claim 1, wherein the second identification unit identifies the first identification utterance as an inquiry utterance according to the utterance type of the utterance of the first speaker, and identifies the second identification utterance according to the utterance type of the utterance of the second speaker after the identified first identification utterance.

3. The classification device according to claim 1,
wherein a model in the first identification model/rule is trained to output, as the utterance type, an estimation result of a first utterance type indicating need hearing, a second utterance type indicating a question, or a third utterance type indicating an explanation or an answer, and
wherein the first identification unit inputs the utterance data into the first identification model/rule, and based on output of the estimation result by the first identification model/rule, identifies whether each of the utterances belongs to the first utterance type, the second utterance type, or the third utterance type.

4. The classification device according to claim 3,
wherein, in a rule in the second identification model/rule,
a rule for identifying the first identification utterance is that the first identification utterance is one in which a speaker of the utterance is the first speaker, and that the utterance type of the utterance of the first speaker is the first utterance type, and
in a rule for identifying the second identification utterance, a condition for a combination of a speaker, and the second utterance type and the third utterance type for each utterance in order of utterances is defined for the dialogue included in the utterance data.

5. The classification device according to claim 1,
wherein a model in the result classification model/rule is trained to classify the response result kind as presence or absence of a need, and
wherein the result classification unit inputs the pair data of utterances into the result classification model/rule, and, as for the dialogue included in the utterance data, classifies the response result kind as the presence or the absence of the need.

6. The classification device according to claim 5,
wherein the model in the result classification model/rule is trained to perform classification to find out a degree of the need, and
wherein the result classification unit inputs the pair data of utterances into the result classification model/rule, and classifies the response result of the dialogue as the response result kind to find out the degree of the need.

7. A classification method for causing a computer to execute processing of:
receiving, as input, utterance data including an utterance of a first speaker and an utterance of a second speaker in a dialogue and, using a first identification model/rule for estimating an utterance type indicating a type of each of the utterances in the dialogue, identifying the respective utterance types of the utterances included in the utterance data;
receiving, as input, the utterance data and the utterance type of each of the utterances, using a second identification model/rule preset according to the utterance types, identifying a first identification utterance indicating an inquiry and a second identification utterance in response to the first identification utterance in the utterance data, and outputting pair data of utterances indicating the first identification utterance and the second identification utterance; and receiving, as input, the output pair data of utterances, and, using a result classification model/rule for classifying a response result of the dialogue as a response result kind, classifying the response result of the dialogue included in the utterance data as the response result kind.

8. A classification program for causing a computer to execute processing of:
receiving, as input, utterance data including an utterance of a first speaker and an utterance of a second speaker in a dialogue and, using a first identification model/rule for estimating an utterance type indicating a type of each of the utterances in the dialogue, identifying the respective utterance types of the utterances included in the utterance data;
receiving, as input, the utterance data and the utterance type of each of the utterances, using a second identification model/rule preset according to the utterance types, identifying a first identification utterance indicating an inquiry and a second identification utterance in response to the first identification utterance in the utterance data, and outputting pair data of utterances indicating the first identification utterance and the second identification utterance; and
receiving, as input, the output pair data of utterances, and, using a result classification model/rule for classifying a response result of the dialogue as a response result kind, classifying the response result of the dialogue included in the utterance data as the response result kind.

9. The classification method according to claim 7, wherein the second identification unit identifies the first identification utterance as an inquiry utterance according to the utterance type of the utterance of the first speaker, and identifies the second identification utterance according to the utterance type of the utterance of the second speaker after the identified first identification utterance.

10. The classification method according to claim 7,
wherein a model in the first identification model/rule is trained to output, as the utterance type, an estimation result of a first utterance type indicating need hearing, a second utterance type indicating a question, or a third utterance type indicating an explanation or an answer, and
wherein the first identification unit inputs the utterance data into the first identification model/rule, and based on output of the estimation result by the first identification model/rule, identifies whether each of the utterances belongs to the first utterance type, the second utterance type, or the third utterance type.

11. The classification method according to claim 7,
wherein, in a rule in the second identification model/rule,
a rule for identifying the first identification utterance is that the first identification utterance is one in which a speaker of the utterance is the first speaker, and that the utterance type of the utterance of the first speaker is the first utterance type, and
in a rule for identifying the second identification utterance, a condition for a combination of a speaker, and the second utterance type and the third utterance type for each utterance in order of utterances is defined for the dialogue included in the utterance data.

12. The classification method according to claim 7,
wherein a model in the result classification model/rule is trained to classify the response result kind as presence or absence of a need, and
wherein the result classification unit inputs the pair data of utterances into the result classification model/rule, and, as for the dialogue included in the utterance data, classifies the response result kind as the presence or the absence of the need.

13. The classification method according to claim 7,
wherein the model in the result classification model/rule is trained to perform classification to find out a degree of the need, and
wherein the result classification unit inputs the pair data of utterances into the result classification model/rule, and classifies the response result of the dialogue as the response result kind to find out the degree of the need.

14. The classification program according to claim 8, wherein the second identification unit identifies the first identification utterance as an inquiry utterance according to the utterance type of the utterance of the first speaker, and identifies the second identification utterance according to the utterance type of the utterance of the second speaker after the identified first identification utterance.

15. The classification program according to claim 8,
wherein a model in the first identification model/rule is trained to output, as the utterance type, an estimation result of a first utterance type indicating need hearing, a second utterance type indicating a question, or a third utterance type indicating an explanation or an answer, and
wherein the first identification unit inputs the utterance data into the first identification model/rule, and based on output of the estimation result by the first identification model/rule, identifies whether each of the utterances belongs to the first utterance type, the second utterance type, or the third utterance type.

16. The classification program according to claim 8,
wherein, in a rule in the second identification model/rule,
a rule for identifying the first identification utterance is that the first identification utterance is one in which a speaker of the utterance is the first speaker, and that the utterance type of the utterance of the first speaker is the first utterance type, and
in a rule for identifying the second identification utterance, a condition for a combination of a speaker, and the second utterance type and the third utterance type for each utterance in order of utterances is defined for the dialogue included in the utterance data.

17. The classification program according to claim 8,
wherein a model in the result classification model/rule is trained to classify the response result kind as presence or absence of a need, and
wherein the result classification unit inputs the pair data of utterances into the result classification model/rule, and, as for the dialogue included in the utterance data, classifies the response result kind as the presence or the absence of the need.

19. The classification program according to claim 8,
wherein the model in the result classification model/rule is trained to perform classification to find out a degree of the need, and
wherein the result classification unit inputs the pair data of utterances into the result classification model/rule, and classifies the response result of the dialogue as the response result kind to find out the degree of the need.

20. The classification device according to claim 1, wherein the response result of the dialogue is classified based on utterance concept in the dialogue
